(19) United States
(12) Patent Application Publication
(10) Pub. No.: US 2024/0171090 A1
(43) Pub. Date: May 23, 2024

(54) GALLIUM-NITRIDE INVERTER

(71) Applicant: AERIS HOSPITALITY SOLUTIONS, LLC., CITY OF INDUSTRY, CA (US)

(72) Inventor: CHI-TING CHEN, TAINAN CITY (TW)

(21) Appl. No.: 18/056,327

(22) Filed: Nov. 17, 2022

(51) Int. Cl. H02M 7/5387

(52) U.S. Cl. CPC H02M 7/5387

(57) ABSTRACT

A gallium-nitride inverter includes a control unit; an H-bridge circuit having four gallium-nitride transistors; a direct-current input end; and an alternating-current output end. In response to an input direct current, the control unit outputs a first control signal and a second control signal alternately to put a first output terminal and a second output terminal at a high potential alternately, so as to form an alternating-current output at the alternating-current output end with enhanced energy conversion efficiency.

### BACKGROUND OF THE INVENTION

### 1. Technical Field

The present invention relates to inverters, and more particularly to an inverter using gallium-nitride components.

### 2. Description of Related Art

Shortage of primary energy sources has made renewable energy increasingly used in various fields. For daily use, a direct current coming from a renewable energy source has to be converted into ab alternating current by means of an inverter.

For example, Taiwan Patent No. 1378633 discloses a DC-to-AC converting device for solar cells, which is to be electrically connected to a direct-current input end of a solar cell for generating an alternating-current output voltage. The prior-art device comprises: a clamp unit, a double-winding step-up transformer, and an inverter unit. The clamp unit has a first low-voltage power switch, a second low-voltage power switch, and a low-voltage capacitor. The transformer has an input winding, an output winding, and a magnetizing inductor connected in parallel with the input winding. When the alternating-current output voltage is during its positive cycle, the first low-voltage power switch is triggered to allow a current to come in at the direct-current input end. Then the input winding and the first low-voltage power switch charge the magnetizing inductor to boost the current flowing through the magnetizing inductor, and the transformer induces the voltage to the output winding.

However, transformers are usually poor in terms of conversion efficiency, and tend to cause energy waste.

### SUMMARY OF THE INVENTION

In view of the shortcomings of the prior art, the present invention provides a gallium-nitride inverter, comprising: a control unit, having a first control end and a second control end; an H-bridge circuit, including a first gallium-nitride transistor, a second gallium-nitride transistor, a third gallium-nitride transistor, and a fourth gallium-nitride transistor that are in electrical connection successively, the first control end being electrically connected to a gate of the first gallium-nitride transistor and a gate of the third gallium-nitride transistor, the second control end being electrically connected to a gate of the second gallium-nitride transistor and a gate of the fourth gallium-nitride transistor, the control unit outputting a first control signal from the first control end to turn on the first gallium-nitride transistor and the third gallium-nitride transistor, the control unit outputting a second control signal from the second control end to turn on the second gallium-nitride transistor and the fourth gallium-nitride transistor, a direct-current input end, being electrically connected to a drain of the first gallium-nitride transistor and a drain of the fourth gallium-nitride transistor; and an alternating-current output end, having a first output terminal and a second output terminal adjacent to each other, the first output terminal being electrically connected to a source of the first gallium-nitride transistor and a drain of the second gallium-nitride transistor, the second output terminal being electrically connected to a source of the fourth gallium-nitride transistor and a drain of the third gallium-nitride transistor, whereby when a direct current is input at the direct-current input end, the control unit alternately outputs the first control signal and the second control signal, so as to put the first output terminal and the second output terminal at a high potential alternately, thereby forming an alternating-current output at the alternating-current output end.

Further, when the control unit outputs the first control signal from the first control end, the first output terminal is at the high potential while the second output terminal is at a low potential, and when the control unit outputs the second control signal from the second control end, the first output terminal is at the low potential while the second output terminal is at the high potential.

Further, a source of the second gallium-nitride transistor and a source of the third gallium-nitride transistor are electrically connected to a ground end, and the low potential has a voltage value that is equal to a voltage value at the ground end.

Further, the gallium-nitride inverter comprises a capacitor, which has one end electrically connected to the first output terminal and an opposite end electrically connected to the second output terminal.

Therein, the high potential has a voltage value that is equal to a voltage value of the direct current.

Therein, each the first gallium-nitride transistor, the second gallium-nitride transistor, the third gallium-nitride transistor, and the fourth gallium-nitride transistor is a high electron mobility transistor (HEMT).

Therein, each of the first control signal and the second control signal is a carrier signal.

With the technical features described above, the present invention preferably provides the following advantages:
1. The need of a transformer is eliminated, yet a 95% or higher conversion efficiency can be achieved, thereby minimizing energy waste.
2. The use of HEMTs helps reduce on resistance, so the need for an additional metal heat-dissipating device can be eliminated.

### BRIEF DESCRIPTION OF THE DRAWINGS

FIG. 1 is a circuit diagram of one embodiment of the present invention.

FIG. 2 is a timing diagram with respect to electric potentials according to one embodiment of the present invention.

### DETAILED DESCRIPTION OF THE INVENTION

With the foregoing technical features, the gallium-nitride inverter of the present invention provides effects as described below with reference to one or more embodiments.

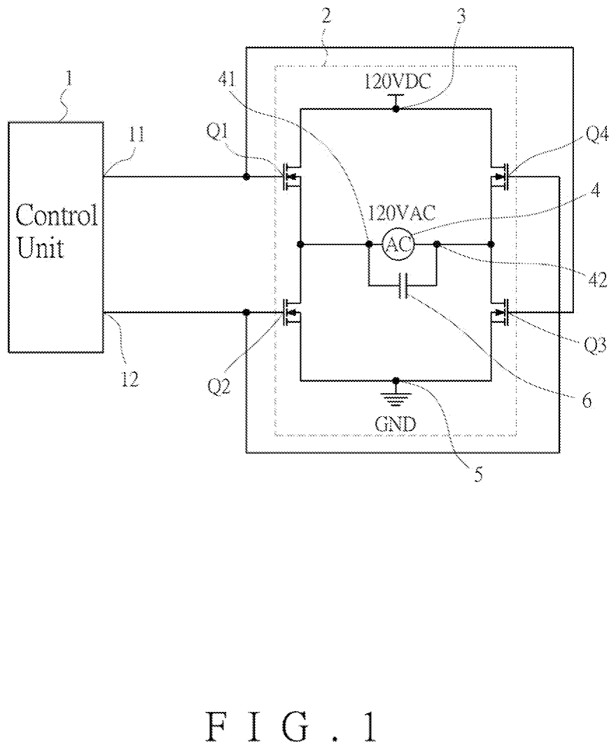

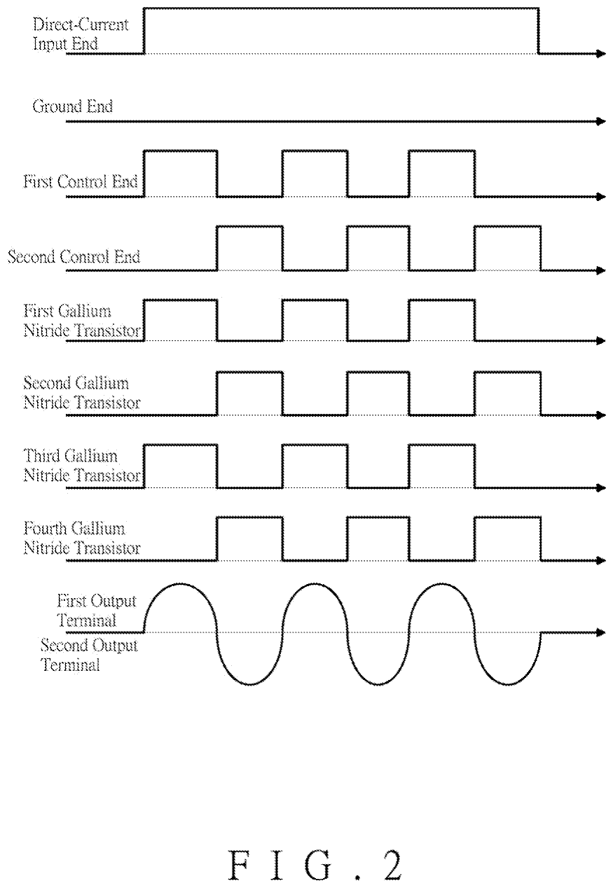

FIG. 1 and FIG. 2 depict a gallium-nitride inverter according to one embodiment of the present invention. Components of the gallium-nitride inverter are now detailed.

A control unit 1 has a first control end 1 land a second control end 12. In the preferred embodiment of the present invention, the control unit 1 is a microprocessor.

An H-bridge circuit 2 comprises four gallium-nitride transistors, including a first gallium-nitride transistor Q1, a second gallium-nitride transistor Q2, a third gallium-nitride transistor Q3 and a fourth gallium-nitride transistor Q4.

Preferably, the first gallium-nitride transistor Q1, the second gallium-nitride transistor Q2, the third gallium-nitride transistor Q3, and the fourth gallium-nitride transistor Q4 are each a high electron mobility transistor (HEMT).

The first control end 11 is electrically connected to the gate of the first gallium-nitride transistor Q1 and the gate of the third gallium-nitride transistor Q3. The second control end 12 is electrically connected to the gate of the second gallium-nitride transistor Q2 and the gate of the fourth gallium-nitride transistor Q4.

The control unit 1 can turn on the first gallium-nitride transistor Q1 and the third gallium-nitride transistor Q3 by outputting a first control signal through the first control end 11. Alternatively, the control unit 1 can turn on the second gallium-nitride transistor Q2 and the fourth gallium-nitride transistor Q4 by outputting a second control signal through the second control end 12. Preferably, the first control signal and the second control signal are each a carrier-wave signal, which may be in the present embodiment a square wave signal, as the waveform of the first control end and the second control end shown in FIG. 2.

A direct-current input end 3 is electrically connected to the drain of the first gallium-nitride transistor Q1 and the drain of the fourth gallium-nitride transistor Q4.

An alternating-current output end 4 has a first output terminal 41 and a second output terminal 42 adjacent to each other.

The first output terminal 41 is electrically connected to the source of the first gallium-nitride transistor Q1 and the drain of the second gallium-nitride transistor Q2. The second output terminal 42 is electrically connected to the source of the fourth gallium-nitride transistor Q4 and the drain of the third gallium-nitride transistor Q.

A ground end 5 is electrically connected to the source of the second gallium-nitride transistor Q2 and the source of the third gallium-nitride transistor Q3.

A capacitor 6 has one end electrically connected to the first output terminal 41 and an opposite end electrically connected to the second output terminal 42.

In use of the gallium-nitride inverter, a direct current, such as a 120-V direct current, is first input at the direct-current input end.

Then the control unit 1 alternately outputs the first control signal and the second control signal, so as to put the first output terminal 41 and the second output terminal 42 at a high potential alternately, thereby forming an alternating-current output at the alternating-current output end 4.

More specifically, when the control unit 1 outputs the first control signal from the first control end 11, the control unit 1 does not output the second control signal, and the first gallium-nitride transistor Q1 and the third gallium-nitride transistor Q3 are turned on.

At this time, the direct current coming from the direct-current input end 3 is led to the first output terminal 41 through the first gallium-nitride transistor Q1, and the third gallium-nitride transistor Q3 makes the potential of the second output terminal 42 equal to that at the ground end 5.

In other words, when the control unit 1 outputs the first control signal, the first output terminal 41 is at the high potential and has its voltage value equal to that of the direct current. The second output terminal 42 is now at a low potential and has its voltage value equal to that at the ground end 5.

Similarly, when the control unit 1 uses the second control end 12 to output the second control signal, the control unit 1 does not output the first control signal, and the second gallium-nitride transistor Q2 and the fourth gallium-nitride transistor Q4 are turned on.

At this time, the direct current coming from the direct-current input end 3 is lead to the second output terminal 42 through the fourth gallium-nitride transistor Q4 instead, and the second gallium-nitride transistor Q2 makes the potential of the first output terminal 41 equal to that at the ground end 5.

Stated differently, when the control unit 1 outputs the second control signal, the second output terminal 42 is at the high potential and has its voltage value equal to that of the direct current, while the first output terminal 41 is at the low potential and has its voltage value equal to that at the ground end 5.

In the present embodiment, the first control signal and the second control signal are each a square-wave signal, so the AC current originally output by each of the first output terminal 41 and the second output terminal 42 is also in the form of square waves.

Further, the capacitor 6 that is non polar is used to convert the alternating current having the square-wave form into an alternating current having the sine-wave form for various home appliances to consume.

By alternately outputting the first control signal and the second control signal, a direct current can be converted to an alternating current while remaining the constant voltage without using any transformer. The present invention secures a conversion efficiency of 95% or more, thereby facilitating energy saving.

Additionally, since the gallium-nitride transistors are all HEMTs, when being driven at a high frequency, they feature for a low dynamic on resistance, which generates less heat during operation. This thus eliminate the need of using any additional metal heat-dissipating device to dissipate heat, such as an aluminum component.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A gallium-nitride inverter, comprising:
a control unit, having a first control end and a second control end;
an H-bridge circuit, including a first gallium-nitride transistor, a second gallium-nitride transistor, a third gallium-nitride transistor, and a fourth gallium-nitride transistor that are in electrical connection successively, the first control end being electrically connected to a gate of the first gallium-nitride transistor and a gate of the third gallium-nitride transistor, the second control end being electrically connected to a gate of the second gallium-nitride transistor and a gate of the fourth gallium-nitride transistor, the control unit outputting a first control signal from the first control end to turn on the first gallium-nitride transistor and the third gallium-nitride transistor, the control unit outputting a second control signal from the second control end to turn on the second gallium-nitride transistor and the fourth gallium-nitride transistor,
a direct-current input end, being electrically connected to a drain of the first gallium-nitride transistor and a drain of the fourth gallium-nitride transistor; and
an alternating-current output end, having a first output terminal and a second output terminal adjacent to each other, the first output terminal being electrically connected to a source of the first gallium-nitride transistor and a drain of the second gallium-nitride transistor, the second output terminal being electrically connected to a source of the fourth gallium-nitride transistor and a drain of the third gallium-nitride transistor,
whereby when a direct current is input at the direct-current input end, the control unit alternately outputs the first control signal and the second control signal, so as to put the first output terminal and the second output terminal at a high potential alternately, thereby forming an alternating-current output at the alternating-current output end.

2. The gallium-nitride inverter of claim 1, wherein when the control unit outputs the first control signal from the first control end, the first output terminal is at the high potential while the second output terminal is at a low potential, and when the control unit outputs the second control signal from the second control end, the first output terminal is at the low potential while the second output terminal is at the high potential.

3. The gallium-nitride inverter of claim 2, wherein a source of the second gallium-nitride transistor and a source of the third gallium-nitride transistor are electrically connected to a ground end, and the low potential has a voltage value that is equal to a voltage value at the ground end.

4. The gallium-nitride inverter of claim 1, further comprising a capacitor, which has one end electrically connected to the first output terminal and an opposite end electrically connected to the second output terminal.

5. The gallium-nitride inverter of claim 1, wherein the high potential has a voltage value that is equal to a voltage value of the direct current.

6. The gallium-nitride inverter of claim 1, wherein each the first gallium-nitride transistor, the second gallium-nitride transistor, the third gallium-nitride transistor, and the fourth gallium-nitride transistor is a high electron mobility transistor (HEMT).

7. The gallium-nitride inverter of claim 1, wherein each of the first control signal and the second control signal is a carrier signal.
